(19) United States
(12) Patent Application Publication
(10) Pub. No.: US 2024/0262975 A1
(43) Pub. Date: Aug. 8, 2024

(54) Process for recovery and exploitation of polyesters and polyamides from waste polymeric artifacts

(71) Applicant: Politecnico di Milano, Milano MI (IT)

(72) Inventors: Flavio TOLLINI, Bergamo BG (IT); Massimo MORBIDELLI, Morcote (CH); Giuseppe STORTI, Lodi LO (IT); Davide MOSCATELLI, Arese MI (IT)

(21) Appl. No.: 18/567,307

(22) PCT Filed: Jun. 7, 2022
(86) PCT No.: PCT/IB2022/055289

§ 371 Date: Dec. 5, 2023

(30) Foreign Application Priority Data
Jun. 9, 2021 (IT) 102021000015005

(51) Int. Cl. C08J 11/22

(52) U.S. Cl. CPC C08J 11/22; C08J 2367/02

(57) ABSTRACT

Method for recovering polyesters and polyamides from the corresponding polymeric waste products, comprising the following steps:
a) Depolymerization of the polyester/polyamide and obtaining the linear and/or cyclic oligomers and/or monomers,
b) Recovery and purification of the products from step a),
c) Polymerization of the product from step b) by polycondensation and/or ring opening polymerization.

In step a) the depolymerization is partial and results in a mixture of oligomers, comprising especially cyclic oligomers and said step is conducted in a polar and/or apolar aprotic solvent at the temperature near solvent boiling temperature, between 100 and 300° C. and in the presence of a catalyst, simultaneously distilling the reaction solvent and the volatile by-products dissolved therein.

### FIELD OF THE INVENTION

The present invention relates to a process for recovery and exploitation of polyesters and polyamides from waste polymeric artifacts. The technology is presented below with reference to a specific polymer of great industrial importance, polyethylene terephthalate (PET).

### BACKGROUND ART

PET is currently produced from bis-2-hydroxyethylterephthalate (BHET) by polycondensation (PC). This reaction requires the 3 steps shown in FIG. 1: one in the liquid state, one in the molten state and one in the solid state. This evolution of the reaction reflects the progressive increase in the viscosity of the polymer, which results in long reaction times and removal of the by-products (especially ethylene glycol, EG) of the reaction. At high viscosities, such removal becomes extremely slow, requiring times of the order of tens of hours for its completion. An alternative method proposed in the literature is Ring Opening Polymerization (ROP, shown in the diagram in FIG. 2). This process involves an initial stage of cyclic oligomer formation by cyclo-depolymerization (CDP) requiring high dilution. Exploiting the resulting low viscosity, the removal of by-products becomes very easy. The cyclic oligomers thus synthesized are then recovered, purified and polymerized by ROP in about one hour, drastically decreasing the polymerization reaction times. From an industrial point of view, however, this process is not economically attractive because the production of cyclic oligomers is thermodynamically favoured only at high dilutions (typical concentrations 10 g/l). Such conditions lead to the need for very high solvent volumes which are difficult to handle economically.

The process which uses polycondensation as a synthesis method is the most widely used in the industry. The polymeric product is marketed in the form of pellets and then processed by manufacturing companies. Depending on the degree of polymerization achieved during the polymerization step (and thus the corresponding chemical-physical properties), several commercial uses are possible. In increasing order of quality, the pellets will then be used to prepare synthetic fibres, laminates, trays, bottles and high-performance technical materials.

As for the end-of-life fate of these polymeric products, and in particular of a PET bottle, it should be noted that this becomes a plastic waste regardless of the process by which the polymer was produced. At this point there is a step of collection, separation (not only by type of plastic but also by colour, use and origin), washing and shredding to obtain the so-called flakes. The quality (and thus the cost) of these flakes depends precisely on the effectiveness of the previous separations and these materials will therefore have different types of treatment, as shown in FIG. 3. The lower-value flakes are the complete blend of different polymers called PLASMIX. Such a mixture can only be landfilled or incinerated or decomposed into mixtures of low molecular compounds by pyrolysis. Alternatively, by means of selection and separation processes it is possible to divide what is recovered from separate waste collection into plastic materials with different qualities. In increasing order, we find synthetic fibres, multilayer films and trays, opaque containers, coloured bottles and transparent bottles. The latter are currently of great interest, as they represent the material most in demand by recyclers since they satisfy most of the prerequisites necessary for the effective operation of different recycling systems.

Different flakes are the raw material of the subsequent recycling processes, which can be classified into two broad categories: chemical and mechanical.

Chemical recycling processes include the depolymerization of PET until its complete transformation into the monomers forming the same. In some cases, depolymerization is only partial, but the polymer thus recovered still needs an adequate repolymerization to bring the molecular weight thereof back to the values necessary to make bottles. In many cases, the monomers recovered for reasons of cost, quality and purity must be mixed with virgin monomers in order to meet market and process requirements. Chemical recycling processes have several advantages: they use mixed flakes, potentially also fibres, laminates, and films. They are versatile from the point of view of the products (possibility of returning to different monomers and also to different chemical compounds) and allow to remove contaminants. On the other hand, they are generally operated by chemical companies, the only ones able to manage plants which require extensive use of solvents, complex purification systems and long process times. Furthermore, the developers of these technologies are the same ones who produce and market the virgin monomers and polymer. This is therefore a versatile and advantageous recycling system for those who already have a classic polycondensation system, as it allows to integrate the monomer supply with a variable fraction of recycled monomers. For the same reasons, plants based on chemical recycling operate at high productivity, i.e., with equipment of high volume and complexity. Currently, these processes constitute only a modest percentage of recycling plants, even more so in the prototype phase or in laboratory and pilot scale. Although this type of process has several advantages, such as the possibility of recycling coloured PET flakes, the removal of contaminants and its versatility with respect to products, it also has important disadvantages, linked in particular to the use of multiple chemical solvents which must then be properly recycled and disposed of.

For processes based on mechanical recycling we can distinguish two macro-technologies, still diagrammed in FIG. 3: in their simplest application, they include the direct extrusion of the flakes, obtaining PET in the form of pellets which can then have different uses. However, mechanical recycling involves a thermal degradation of the polymer, thus obtaining a PET with a lower molecular weight than the starting one. Typically, although starting from bottle flakes, a material is obtained which can be used for products of lower value, such as synthetic fibres. Such a recycling system is therefore called “open” or, more explicitly, “from bottle to fibre”. To overcome this limitation, the most recent mechanical recycling processes, called super-clean, include a re-polymerization step (solid state polymerization) just before or just after the last extrusion step. Thereby, the final polymer returns with adequate quality for the production of bottles and the recycling system becomes “closed”, or “from bottle to bottle”. The strengths of this method are cost-effectiveness, ease of implementation (no solvents required) and process scale adaptable to recycling needs (small scales possible). On the other hand, it is not possible to perform any purification (except for the partial removal of the most volatile pollutants): this forces to use only monochrome flakes of high quality and cost, which makes the process poorly flexible. Currently, more than 80% of recycled bottles use mechanical recycling processes. The other forms of PET are therefore not recycled, as they would be too degraded by a mechanical process.

It should be noted that the recycling process subject of the present invention is (i) applicable not only to high-quality polyesters for bottles (PET) but also to polyester and polyamide fibres and (ii) does not have the drawbacks of the technologies described above.

Kamau S. D. et al.: “Cyclo-depolymerization of poly(propylene terephthalate): some ring-opening polymerizations of the cyclic oligomers produced polymers for advanced technologies, Wiley & Sons, Bognor Regis, GB, vol. 14, no. 7, 1 Jul. 2003 (2003 Jul. 1), p. 492-501, discloses a method for recycling polyester, in which the polyester polymers are initially subjected to a cyclo-depolymerization process to produce a mixture of cyclic oligomers, used as starting monomers in a ring-opening polymerization.

EP3778744 A1 discloses processes for recycling post-consumer polyethylene terephthalate (PET), comprising the partial depolymerization of the post-consumer PET to produce PET oligomers, followed by repolymerization of the partially depolymerized PET with PET oligomers. The process produces a polymeric PET material comprising recycled PET oligomers. The process can also be combined or integrated with a virgin PET manufacturing process to produce a polymeric PET material, composed of recycled PET oligomers and virgin PET monomers.

Hodge Philip ED-Liou guey-Sheng et al: “Cyclodepolymerization as a method for the synthesis of macrocyclic oligomers”, Reactive and Functional Polymers, vol. 80, pp. 21-32, describes the preparation of macrocyclic oligomers by cyclo-depolymerization of condensation polymers. This approach can provide the synthesis of many macrocycles in a single step.

EP3606980 A1 discloses a process for the preparation of cyclic oligomers, which involves the reaction of a polyester cyclic oligomer composition comprising a polyester cyclic oligomer having two to five furan units. The process involves reacting a bifunctional derivative of furan and a diol in a linear oligomerization stage, to produce a linear oligomeric composition, followed by a stage in which the linear oligomer composition is reacted in a distillation-assisted cyclization (DA-C) step, to form a polyester cyclic oligomer composition and removal of a diol by-product by evaporation.

### SUMMARY OF THE INVENTION

The applicant has now found a process which, while being a chemical process as it contemplates a partial cyclo-depolymerization associated with a simultaneous distillation of the solvent, is a fast process capable of removing most of the by-products and contaminants. Moreover, by operating in the presence of a catalyst and at an appropriate dilution, the polymer is only partially degraded and the degradation products are essentially cyclic oligomers. Thereby, the material which is recovered is ready to be repolymerized by ROP, reaching bottle grade in less than 30 minutes.

With respect to the conventional chemical processes, this approach has the indisputable advantage that complete depolymerization is not required. Furthermore, by reducing the complexity of the process and the number of solvents to be used compared to a traditional chemical recycling process, it is achievable not only by large industrial companies but also by small and medium-sized industries.

An object of the present invention is therefore a process for recovering polyesters and polyamides from the corresponding polymeric waste products, comprising the following steps:
a) Total and/or partial depolymerization of the polyester/polyamide and obtaining the linear and/or cyclic oligomers and/or monomers;
b) Recovery and purification of the products from step a);
b) Polymerization of the product from step b).

This process is characterized in that step a) is conducted in a polar and/or apolar aprotic solvent starting from concentrations of said polymeric product in said solvent between 10 and 800 g/l at the temperature close to the solvent boiling point, between 100 and 300° C., and in the presence of a catalyst, simultaneously distilling the reaction solvent and the volatile by-products dissolved therein. Only by carrying out step a) in this manner is it possible to conduct a partial depolymerization in which the mixture of oligomers consists mainly of cyclic oligomers.

### DESCRIPTION OF THE FIGURES

FIG. 1 shows the traditional pattern of industrial polymerization of PET by polycondensation.

FIG. 2 shows the pattern of polymerization of PET by ring-opening polymerization (ROP).

FIG. 3 shows the current, separation and treatment chain of the different polymer fractions. In particular, the materials suitable for the different treatments are identified.

FIG. 4 shows the conversion results and the number average molecular weight as a function of time obtained using conventional cyclo-depolymerization (CDP) and distillation-assisted cyclo-depolymerization (DA-CDP) according to the present invention, at different initial PET concentrations.

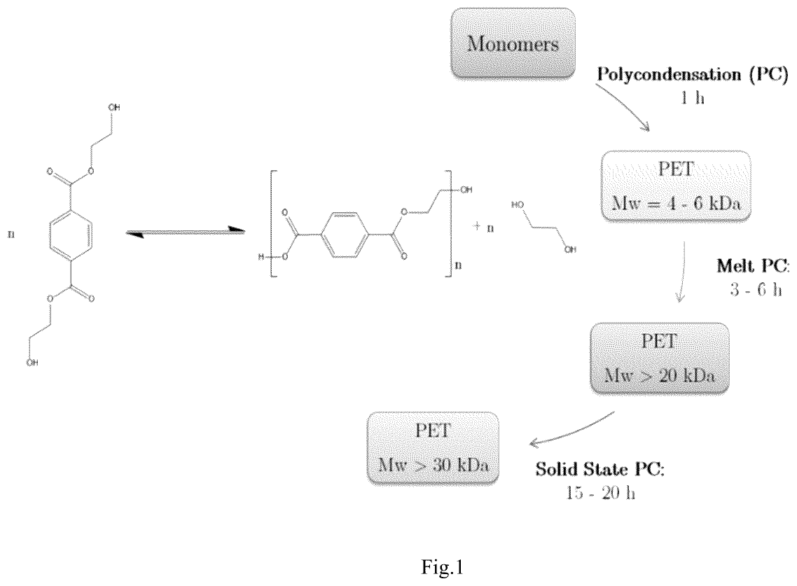

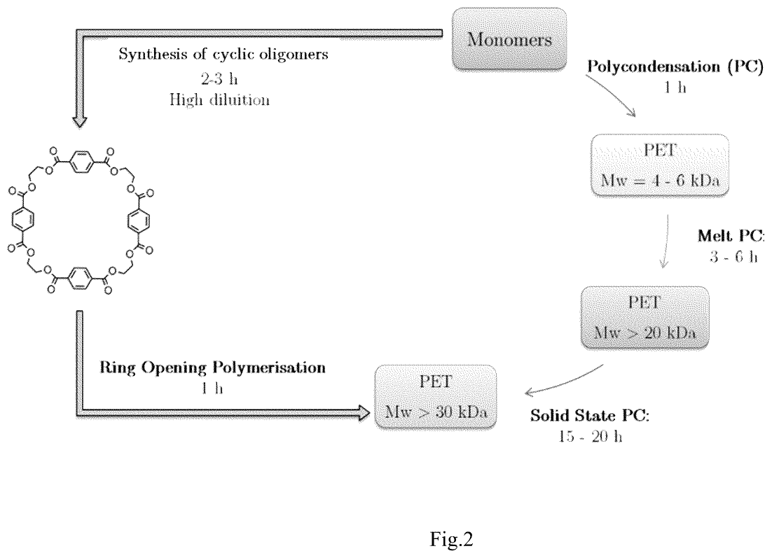

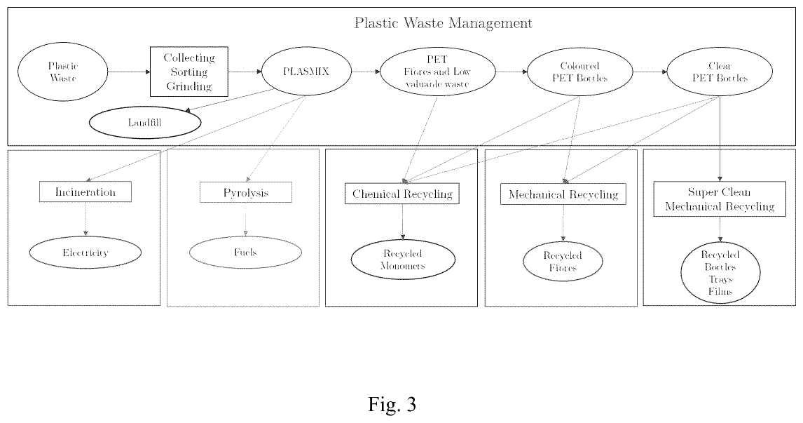

FIG. 5 shows a block diagram of the process of the following invention with greater detail related to the second step of the process (purification and recovery of the product). In particular:
in process b1) the system for the selective separation and purification of the polymeric and oligomeric fractions is diagrammed;
in process b2) a direct crystallization process with multi-step washing is diagrammed by means of a single solvent or mixture of solvents at constant and/or variable temperature;
in process b3) a direct crystallization process with counter-current washing is diagrammed.

With regard to products leaving the third step of the process object of the present invention, FIG. 6 shows:
percentage conversion to PET as a function of the reaction time;
the number average molecular weight of the polymer as a function of the reaction time;
the number average molecular weight as a function of the percentage conversion to PET with two different scales.

All these results refer to products exiting the third step of the process of the present invention (step c) from polymer/oligomer mixtures obtained after the recovery and purification step according to different methods (step b). Such mixtures are referred to as raw, hot, cold, and mix (cold+hot), and their features will be explained below.

### DETAILED DESCRIPTION OF THE INVENTION

For the purposes of the present invention, the definition comprising does not exclude the presence of additional components or steps not expressly mentioned after such a definition.

For the purposes of the present invention, the definitions consisting of, and consisting in do not exclude the presence of additional components or steps other than those listed after such definitions.

For the purposes of the present invention, cyclo-depolymerization means a depolymerization which results in a mixture of polymers of different molecular weights, in particular high molecular weight polymers and low molecular weight cyclic oligomers. For the purposes of the present invention, partial depolymerization means a depolymerization reaction in which the fraction of depolymerized polymer is between 0.1% and 80%, preferably between 0.1% and 40% by weight on the total weight of the starting polymer.

For the purposes of the present invention:
a) polycondensation means a polymerization reaction involving the bonding of two linear chains of any length with the release of a low molecular weight by-product;
b) polymer chemolysis means the depolymerization reaction opposite to polycondensation, which involves the polymer breaking into two shorter chains favoured by the insertion in the chain of one or more molecules which promote the polymer chain breaking;
c) polymer decomposition means the depolymerization reaction opposite to polycondensation and involving the breakage of the polymer into two shorter chains due to degradation of the polymer chain (e.g., mechanical, thermal, physical stress, oxidation, irradiation, etc.);
d) ring opening polymerization or ROP is instead the polymerization reaction by opening a cyclic oligomer;
e) back biting refers to a cyclo-depolymerization reaction opposite to ROP, which therefore involves the breakage of the polymer with the formation of a shorter linear chain and a cyclic oligomer;
f) end biting is a cyclo-depolymerization reaction which involves a head-to-toe closure of an oligomeric linear chain to form a cyclic oligomer and a low molecular weight by-product; the reverse reaction is a ring opening reaction caused by the low molecular weight by-product through which an oligomer is formed with the same repetitive units as the starting cyclic oligomer.

The PET is mainly produced in two qualities: fibre grade and bottle grade. These standards differ mainly in the average molecular weight and in the production recipes such as the amount and type of comonomers, dyes and stabilizers.

For the purposes of the present invention, fibre grade PET is intended as polyethylene terephthalate having a molecular weight between 15000 and 20000 g/mol and an intrinsic viscosity between 0.55 and 0.67 dl/g. Fibre PET for technical yarns such as tyre cords has a higher molecular weight (intrinsic viscosity 0.95 dl/g).

For the purposes of the present invention, bottle grade PET is intended as polyethylene terephthalate having a molecular weight between 24000 and 36000 g/mol and an intrinsic viscosity between 0.75 and 1 dl/g.

For the purposes of the present invention, high molecular weight polymer means a polymer having a number average molecular weight between 20000 and 40000 g/mol.

Low to medium molecular weight oligomers are defined as oligomers with a molecular weight between 1000 and 3500 g/mol.

Very low molecular weight oligomers are defined as oligomers with a molecular weight between 200 and 1000 g/mol.

In the process according to the present invention, polyester polymer products are understood as all compounds having a percentage of polyester between 1 and 100%. In the process according to the present invention, polyamide polymer products are understood as all compounds having a percentage of polyamide between 1 and 100%. In the process according to the present invention, polyester means all the polymers belonging to such a chemical category such as: polyethylene terephthalate (PET), polyethylenefuranoate (PEF), polybutylene terephthalate (PBT), polyethylene naphthalate (PEN), poly(butyleneadipate-terephthalate) (PBAT), polytrimethylene terephthalate (PTT), polybutylene succinate (PBS), unsaturated polyesters (UPE), polylactic acid (PLA), polyhydroxyalkanoates (PHA), etc.

In the method according to the present invention, polyamide means all the polymers belonging to such a chemical category such as: polyamide 6 (Nylon 6), polyamide 11 (Nylon 11), polyamide 12 (Nylon 12), polyamide 66 (Nylon 66), polyamide 610 (Nylon 610), polyamide 66/610 (Nylon 66/610), polyamide 6:12 (Nylon 6/12), polyamide 666 (Nylon 666 or 6/66), polyamide 6/69 (Nylon 6/69), Nylon 1010, Nylon 1012, polyarylamide, polyaramides (Kevlar®), polyphthalamide, polyamidoamines, etc.

In the method according to the present invention, flakes of polyethylene terephthalate bottles, i.e., the shredding/grinding products of PET bottles, are preferably employed as waste polymer products.

Other waste products used as starting material are containers for packaging in polyester such as: food trays, films, etc.

Other waste products used as a starting material are polyamide plastic products such as: automotive components, tubes, containers, packaging, technical materials, etc.

Other waste products used as starting materials are shredded polyester fibres, such as: shoes, clothes, covers, cords, etc., and polyamide fibres, such as Nylon 6, Nylon 6,6, Kevlar, etc.

For the purposes of the present invention, stabilizers are those antioxidant compounds such as poly-substituted phenols, phosphites, etc., usually used to prevent the degradation of the polymer during processing.

For the purposes of the present invention, perfomers are those compounds capable of modifying the rheological and mechanical properties of the polymer.

In the process according to the present invention, in step a) the cyclo-depolymerization is carried out by simultaneously distilling the solvent. Thereby, in addition to the solvent, the low boiling by-products are also removed which, in the specific case of PET, comprise ethylene glycol and water.

The aprotic polar solvent is preferably selected from a diaryl ether, mono/di/tri-C1-C3-alkoxy-benzene, aryl-C1-C3-alkyleneoxy-C1-C5-alkane, di-(aryl-C1-C3-alkylene)-ether, aryl-C1-C3-alkylene-oxo-benzene, C4-C6 cycloalkyl-ketone, in which the aryl is a phenyl or a phenyl substituted with one or more linear or branched C1-C3 alkyl residues. More preferably, the solvent is selected from: diphenyl ether, 1,3 dimethoxybenzene, benzyl methyl ether, benzyl butyl ether, di-benzyl ether, cyclohexanone, benzophenone, more preferably diphenyl ether.

The apolar solvent is preferably a C5-C8 linear hydrocarbon, more preferably it is n-hexane.

The step a) of the process according to the present invention is preferably conducted at a pressure between 100 and 1000 mbar, more preferably between 200 and 500 mbar, more preferably in the presence of inert gas, even more preferably under nitrogen.

The catalyst is selected from cyclic tin octanoate, dibutyltin oxide, 2-ethylhexanoate tin, more preferably it is 2-ethylhexanoate tin. The concentration of the catalyst is preferably between 0.001 and 0.5% weight/weight of the polymer product.

The concentration of the polymer in the solvent in step a) is preferably between 10 and 800 g/l, more preferably between 50 g/l and 400 g/l.

When in particular the waste polymer products are PET bottle flakes or polyester fibres, step a) is conducted by using diphenyl ether as solvent, at a reaction temperature preferably between 100° and 240° C., at pressures between 100 and 1000 mbar, preferably in inert gas, more preferably nitrogen, and for a time between 1 and 5 hours. According to a particularly preferred solution, when the starting polymer material consists of coloured polyethylene terephthalate bottle flakes, the solvent in step a) is diphenyl ether and step a) is conducted at temperatures between 200 and 224° C., at pressures between 200 and 600 mbar, for a time between 2 and 4 hours.

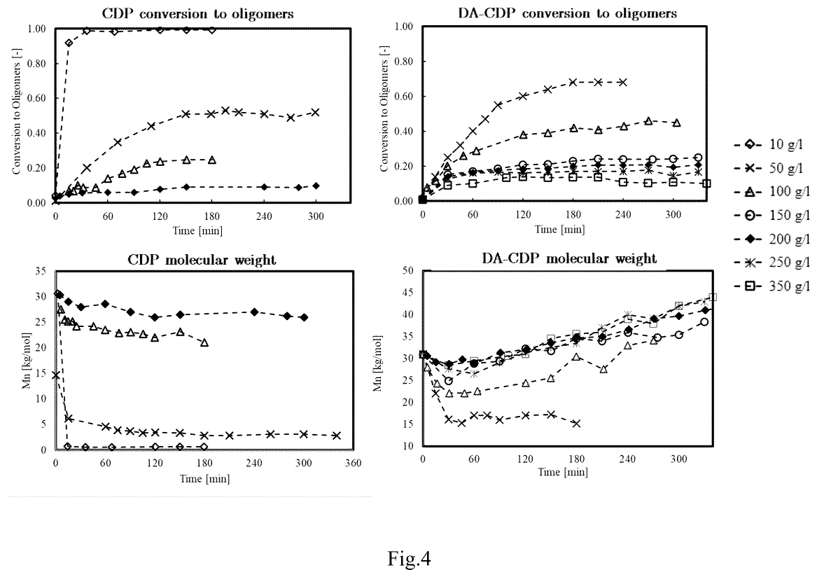

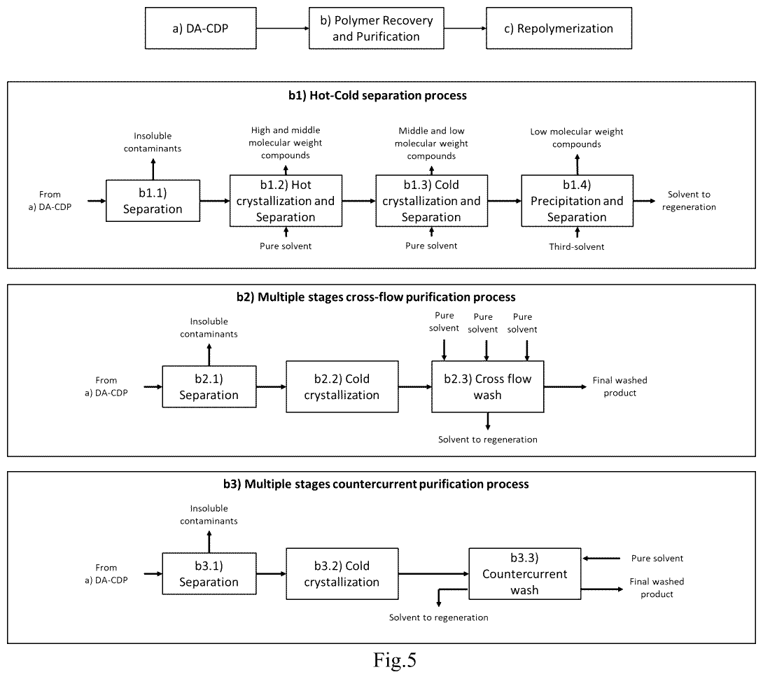

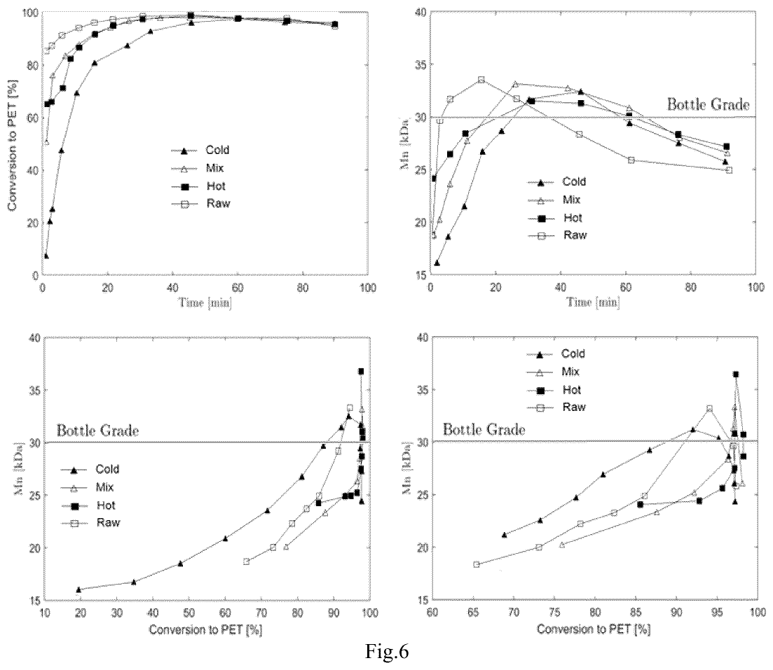

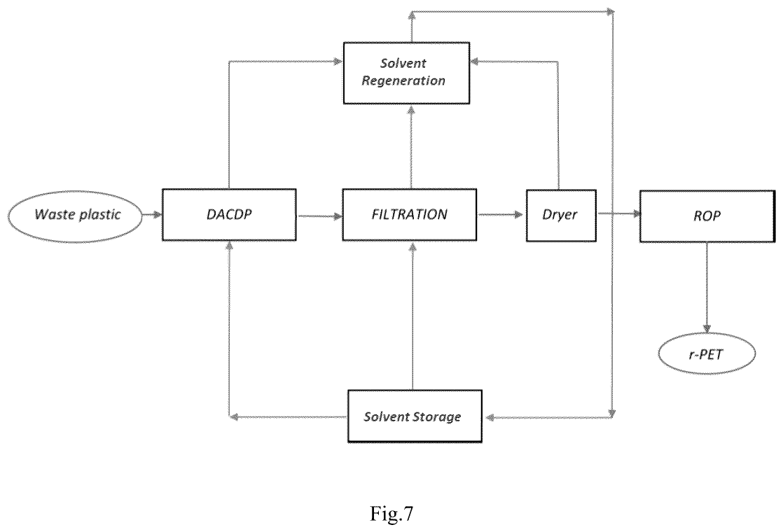

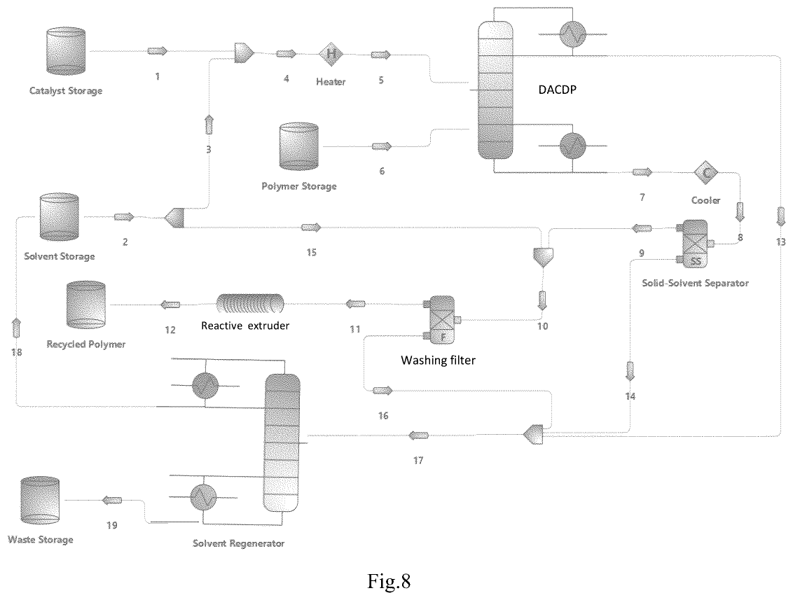

Step a) of the process is depolymerization. This treatment causes a decrease in the molecular weight of the polymer due to chemolysis and back-biting (or cyclo-depolymerization) reactions. As already known in the literature (and experimentally verified), a normal cyclo-depolymerization without evaporation of solvent involves a progressive decrease in the production of cyclic oligomers as the concentration of the PET increases. This behaviour is shown in FIG. 4 (left graphs) and is a consequence of the fact that the back-biting reactions are disadvantaged with increasing PET concentration. At very high dilutions, such a depolymerization is virtually complete, with almost exclusively cyclic oligomer formation.

If the same reaction is carried out with simultaneous distillation (FIG. 4, right graphs), multiple advantages are obtained:
1) The elimination of volatile contaminants originally present in the waste polymer but also of any volatile impurities linked to the use of the polymer during its life (mechanical deterioration, absorption of contaminants, flavourings, etc.).
2) Eliminating the by-products of the aforementioned reactions, such as ethylene glycol and water, by distillation, the conversion to cyclic oligomers can be increased. This occurs because eliminating the by-products favours the end-biting reaction. For example, working at a polymer concentration of 100 g/l (yellow line), the cyclic oligomer content goes from about 20% in the case of cyclo-depolymerization alone to about 40% in the case of cyclo-depolymerization assisted by distillation, DA-CDP.
3) At the same time, the elimination of by-products brings a second advantage: by removing the reaction by-products, polycondensation reactions which increase the molecular weight of the non-depolymerized polymer even beyond the value required by the bottle grade are favoured.

In other words, the classical process of cyclo-depolymerization involves the depolymerization of the polymer with the formation of cyclic oligomers favoured by high dilutions. Under the same operating conditions, the combined use of distillation produces: (i) an increase in the yield of cyclic oligomers, (ii) an increase in the molecular weight of the residual polymer, and (iii) the elimination of volatile pollutants.

Step b) of the process of the present invention comprises several solutions for purifying the product of step a). The first possibility b1) allows the separation of the polymer and oligomers and preferably comprises four stages in series, of which the latter is optional. The second possible route b2) comprises a direct purification system with cross-flow multistage washes. The third possible option b3) comprises a direct purification process with counter-flow multistage washes with preferably a continuous washing and extraction process. An exemplary diagram, summarizing the different options considered, is presented in FIG. 5.

The possible purification system b1) is called “Hot-Cold separation and purification system”. This comprises the selective separation of high, medium, low, and very low molecular weight compounds by operating with a selective precipitation and washing of the collected fractions.

The first (step b1.1), comprises a step of eliminating the insoluble impurities, preferably by filtration, centrifugation or decanting of the reaction mixture from step a) at the solvent boiling temperature. These insoluble impurities are different, for example: inorganic fillers (additives added to facilitate the processing of the polymer during the preparation of the product), metals (typically catalysts added during the synthesis of the polymer) and other insoluble plastics in the reaction solvent (residues of different polymers due to incomplete separation of the flakes).

The subsequent step b1.2) comprises a cooling process of the reaction mixture to the temperature at which the high molecular weight polymer fraction (not depolymerized) precipitates, which is recovered by filtration; in the case of PET, this temperature is between 140 and 180° C., preferably between 140 and 160° C.

After the removal of the polymer, a subsequent step b1.3) comprises a system in which the permeate is subjected to further cooling to about room temperature. Low and medium molecular weight cyclic oligomers are precipitated at this temperature, which are still recovered by filtration.

Lastly, the method of the invention can include a step b1.4) in which the filtered solution from step b1.3) is added with a hydrocarbon solvent, preferably n-hexane, to allow the precipitation of the lower molecular weight oligomers.

When the waste products are polyethylene terephthalate flakes and the solvent of step a) is diphenyl ether, the cooling temperature of step b1.2) is between 140 and 160° C. and the temperature at which the product is washed in step b1.2) is between 90 and 120° C.

Since any dyes remain in solution, both the precipitate, consisting essentially of the unreacted polymer recovered at the boiling (hot) temperature, and the oligomers, which precipitate at room temperature (cold), appear as white powders. Any traces of colours are linked to residues of solvent containing the original dyes of the waste polymer. If the precipitation is carried out by cooling directly to room temperature, a solid powder consisting of PET and cyclic oligomers is obtained which however retains all non-volatile impurities and dyes. Such a product will be indicated as raw before removal of the solvent.

The possible purification system b2) is called “direct separation and purification system with cross-flow washing”. This process allows to directly obtain a polymer-oligomer mixture by operating with cross-flow purification. The first (step b2.1), comprises a step of eliminating the insoluble impurities, preferably by filtration, centrifugation or decanting of the reaction mixture from step a) at the solvent boiling temperature. These insoluble impurities are different, for example: inorganic fillers (additives added to facilitate the processing of the polymer during the preparation of the product), metals (typically catalysts added during the synthesis of the polymer) and other insoluble plastics in the reaction solvent (residues of different polymers due to incomplete separation of the flakes).

The next step b2.2) comprises a process of cooling the reaction mixture to about room temperature with precipitation of the high molecular weight (non-depolymerized) polymer fraction together with the low and medium molecular weight cyclic oligomers. After crystallization, the solid material from step b2.2) is then washed and purified with a cross-flow multistage process. In the latter step, the contaminant-rich solvent from step a) is initially removed and the residual solid product obtained is washed with pure solvent.

The successive washes can be carried out with the same solvent or/and with a different solvent than that used by step a). The multiple wash process can be carried out with a variable washing solvent temperature, for example increasing or decreasing along the wash process. The temperatures typically used cover the range between ambient temperature and the boiling point of the washing solvent used. This process allows for greater flexibility in the purification and washing process.

The possible purification system b3) is called “direct separation and purification system with counter-current washing”. This process allows to directly obtain a polymer-oligomer mixture by operating with counter-current purification. The first (step b3.1), comprises a step of eliminating the insoluble impurities, preferably by filtration, centrifugation or decanting of the reaction mixture from step a) at the solvent boiling temperature. These insoluble impurities are different, for example: inorganic fillers (additives added to facilitate the processing of the polymer during the preparation of the product), metals (typically catalysts added during the synthesis of the polymer) and other insoluble plastics in the reaction solvent (residues of different polymers due to incomplete separation of the flakes).

The next step b3.2) comprises a process of cooling the reaction mixture to about room temperature with precipitation of the high molecular weight (non-depolymerized) polymer fraction together with the low and medium molecular weight cyclic oligomers. After crystallization, the solid material from step b3.2) is then washed and purified with a counter-current multistage process. In the latter step, the contaminant-rich solvent from step a) is initially removed and the residual solid product obtained is washed with pure solvent. The washing can be carried out with the same solvent or/and with a different solvent than that used in step a). The process of washing and extracting contaminants can be carried out continuously with a variable washing solvent temperature, for example increasing or decreasing along the washing process. The temperatures typically used cover the range between ambient temperature and the boiling point of the washing solvent used. This process allows greater flexibility in the purification and washing process and a strong reduction in the volumes of solvent used.

The polymerization reaction or step c) of the process is preferably carried out at a temperature between 220 and 280° C., with nitrogen flow and without the addition of further catalyst.

In order to study the effect of the starting material on the evolution of the reaction, four different starting materials were tested: the two hot and cold precipitates already described, the raw precipitate and one obtained by mixing hot and cold (mix) in proportions such as to reproduce the content of PET and cyclic oligomers of the raw product. The latter material thus represents the equivalent of the raw material but is free of residual solvent, dyes and other impurities.

FIG. 6 shows the number average molecular weight data measured as a function of the conversion to polymer obtained by ROP from the various materials now described. In all cases, it was possible to produce a recycled polymer capable of meeting the specific bottle grades. As predicted by the average molecular weight data as a function of the conversion (FIG. 6, graph at the bottom right), the hot material repolymerizes almost exclusively by polycondensation while the cold one by ROP. If the mixture called mix (hot+cold) is used as a reagent, both polymerization reactions are present. The raw material has a short initial induction period (FIG. 6, conversion-time graph), probably due to the presence of solvent whose evaporation limits the reaction temperature in the first steps, followed however by fast kinetics. The growth of molecular weight is also very fast but followed by a purely rapid deterioration, certainly due to the presence of residual contaminants. Based on these results it was decided that the most promising material is precipitated as a mixture of PET and cyclic but purified oligomers (mix). It was then verified that such material was also obtainable by direct precipitation at a temperature such as to ensure a good recovery of polymer and oligomers while maintaining in solution dyes and other impurities or additives soluble in the solvent. In this case, if the waste is PET flakes or fibres, the preferred temperature is between 25 and 30° C. Finally, to eliminate impurities it is preferable to rinse the precipitate with hot solvent, preferably at temperatures between 90 and 120° C.

According to the present invention, step c) of repolymerization can be conducted using any of the products of step b) in its possible variants:
high molecular weight polymers from step b1.2),
low/medium molecular weight oligomers from step b1.3),
lower molecular weight oligomers from step b1.4),
the polymeric-oligomeric mixture from purification method b2),
the polymeric-oligomeric mixture from purification method b3).

Alternatively, step c) of the inventive process can be carried out starting from mixtures of the products detailed in the above list.

Finally, in step c) dyes, stabilizers and additives (performers) are preferably added in order to allow to obtain a final polymer with the same application properties as virgin polymers.

The physical chemical equivalence between the polyester obtained by the method according to the present invention without any additives and the virgin polymer is confirmed by the equality of the permeability values of the two materials.

The Applicant has further found that the food contaminants associated with the normal use of the polymer, e.g., for PET bottles, can also be removed by the method of the invention. This is achieved in the process in which polymer precipitation is performed followed by washing the precipitate with a solvent such as diphenyl ether.

To verify this, Regulation (EC) no. 282/2008 was followed, which calls for the challenge test, i.e., the introduction of known quantities of polluting compounds (surrogates) and the tracking of the subsequent removal up to residual concentration values which do not represent a risk for human health.

It was chosen to study two cases for the test: one at low and one at high concentrations of contaminants. To simulate the absorption of food flavourings in the PET, the flakes were left to macerate in a 2.5% solution of limonene and menthol at 50° C. for 12-72 h. The stabilizers were instead inserted in one case at 0.15% and in the other case at 0.5% directly in the reaction environment. The results of the analyses on the distillate allowed to verify how, after 5 hours of reaction, not only the EG and water but also the less volatile additive, menthol (boiling temperature of 209° C.), whose removal was estimated at 81% in the case of low contamination, were eliminated.

Given the overlapping of the characteristic peaks of the flavourings and stabilizers, the removal efficiency was quantified by defining the following three parameters: the PET/impurity ratio, the purity of the PET and the residual solvent/PET ratio (diphenyl ether was used as solvent in these tests).

By simply rinsing with pure solvent, preferably at a temperature between 90 and 120° C., it is possible to replace the “dirty” solvent which remains in the filtered polymer with “clean” solvent, i.e., free from impurities (flavourings and stabilizers of the polymer). Thereby, an overall removal of impurities of 84 and 97% in the two cases was estimated. Furthermore, the total removal of menthol in the two process steps a) (DA-CDP) and b) (filtration) reaches values from 95 to 99.5%.

Finally, the impurities constituted by the residual solvent are eliminated during the polymerization or step c). In fact, it was seen that after 10 minutes of reaction under nitrogen flow, 99.99% of the solvent was removed and after another 20 minutes under vacuum the traces of residual solvent reached values lower than the sensitivity threshold of NMR 300 Mhz used for characterization. Accordingly, it can be stated that the final solvent concentration is lower than the sensitivity of the state of the art, estimated at 10 ppm.

In particular, if in step b) after the hot precipitation of the by-products a direct cold filtration is carried out and a subsequent washing with pure solvent, in step c) of polymerization a removal of the semi-volatile compounds up to 99.5%, up to 97% for heavy compounds and greater than 99.9% for the solvent is also obtained.

A further object of the present invention is the process of the invention in which at least one of the steps a)-c) is conducted continuously,

A further object of the present invention is the process of the invention in which at least two of the steps a)-c) are conducted continuously.

Further subject of the present invention is the process of the invention in which all the steps a)-c) are conducted continuously.

One preferred embodiment of the continuous process of the invention is shown in the block diagram of FIG. 7.

After passing a separation process, the plastic waste is introduced together with the solvent premixed with the catalyst into the first continuously operating reactor called DACDP. This reactor consists of a continuously operating system in which the cyclo-depolymerization reaction occurs with distillation. The type of reactor can, for example, be of the continuous stirring tank reactor (CSTR) type, such as a reactor chosen from a paddle mixer reactor, a ribbon mixer reactor, etc. designed to ensure an effective removal of the volatile ingredients and the solvent.

After a residence time of 20 min-2 h, the product obtained at the bottom of the reactor consisting of the unreacted polymer together with its solvent-solubilized oligomers is pumped to a continuous and/or semi-continuous filtration system such as membrane filtration, permeation, press-filter, filter press, etc. to separate the solid stream (polymer+oligomers) from the solvent rich in non-volatile contaminants.

The polymer thus collected is then sent to the re-polymerization system which can consist of a drying system (e.g., drum) and is subsequently subjected to a direct re-polymerization in an extruder or a combined drying-repolymerization system operated with an extruder including degassing and devolatilization system.

All the solvent streams are conveyed to a solvent regeneration system which can work by distillation, microfiltration, adsorption. Thereby the regenerated solvent can be reused in a closed loop within the described process.

FIG. 8 shows the layout of a preferred embodiment of the system in which the continuous process contemplated in FIG. 7 is conducted.

As can be seen from this figure, the solvent coming from the storage tank (solvent storage) is sent in part to the reactor where it is mixed together with the catalyst before entering the DACDP depolymerization plant. The polymer to be recycled from the relative tank (Polymer storage) is also supplied to the reactor through line 6. The depolymerized products exit from the bottom of the DACDP reactor together with the unreacted polymer, which are subsequently sent after cooling to a solid solvent separator. The recovered solid is passed over filter (Washing filter), is washed with solvent coming partly from the storage tank (lines 2 and 15) and partly from the solvent separated in the solvent solid separator. The solid product exiting the wash is sent through line 11 to the reactive extruder and subsequently sent to the recycled polymer storage tank.

The solvent stream distilled in the DACP (line 13), that of the solvent exiting the solvent solid separator (line 14) and that coming from the washing (line 16) are sent to the solvent regenerator from which the regenerated solvent exits from the head which is sent to the storage tank through line 18, while all the waste and impurities are conveyed to the waste tank through line 19.

Some examples of the process of the invention, carried out in a discontinuous manner, are given below for illustrative purposes, but not limiting the process according to the present invention.

### I) Materials Used for the Reactions Described in the Examples and for the Related Analysis:

Swiss Alpina Bottle, CocaCola® Bottle, Sprite® Bottle, Fanta® Bottle, Valser® Bottle, Rivella Fresh® Bottle, 2-Isopropyl-5-methylcyclohexanol (Menthol, Merck, 98%), p-Mentha-1,8-diene (Limonene, Merck, 98%), Irganox® B 561 FF (BASF), Irgafost: 126 (BASF), Dibutyln oxide (Bu2SnO, Merck, 98%), anhydrous ethylene glycol (EG, Sigma Aldrich, 99.8%), Diphenyl ether (DPhE, Aldrich, Reagent Plus®, 99%), trifluoroacetic acid (TFA, Fluorochem, 99%) and potassium trifluoroacetate (K-TFAc, Aldrich, 98%), dichloromethane (DCM, Fisher, 99.99%), hexafluoroisopropanol (HIP, Fluorochem, 99.9%). Chloroform-d (CDCl3, Armar Chemicals, 99.8%) and trifluoroacetic acid-d (TFA-d, Cambridge Isotope Laboratories, 99.5%) were mixed in 3:1 ratio. Initiators and tin oxide dibutyl were stored in a glove box in nitrogen atmosphere. To compare the recycled PET (r-PET) obtained with the process of the invention with the bottle grade PET, samples of the latter were taken from PET bottles.

To estimate the accuracy of the molecular weight analytical methods, PET and PMMA standards were obtained from PSS (Polymer Standards Service, Germany).

### II) Analytical

1H NMR (300 MHz) spectra were recorded on Bruker Avance III spectrometers. The NMR spectra were compared with those of the residual solvent. The conversion values and weight and number average molecular weight, Mn and Mw, of the PET samples were determined by size exclusion chromatography (SEC). An Agilent 1100 GPC/SEC unit with a PFG M (PSS) linear column connected to an Agilent 1100 VWD/UV detector operating at 313 nm, a DAWN HELEOS II multi-angle laser followed by an Optilab TrEX RI refractive index detector (both Wyatt Technology Europe) was used for this purpose. The samples were eluted in HFIP spiked with 0.03 M K-TFAc at 1 mL/min at room temperature. The conversion was measured with WinGPC Unichrom PSS software, as the fraction of PET with respect to the total UV signal area. The absolute molecular weights were measured with Wyatt ASTRA software (dn/dc (PET)=0.249 mL/g). The NMR measurements were performed using PET samples with a concentration of 0.4 mg/mL dissolved in pure TFA-d or in 1:3 TFA-d/CDCl3 volumetric ratio.

### Example 1. Partial (Cycle)-Depolymerization of PET Bottles Assisted by Distillation

A four-necked flask was used, heated by a heating mantle provided with magnetic stirring or alternatively fitted with mechanical stirring through one of the necks. The first neck was used to measure the reaction temperature. The second lateral neck was used during the reaction to take the reaction samples by means of a spatula. These samples were then dried in an oven at 120° C. In the central neck a Vigreux column was installed with a condenser in the head to which a flask was connected to collect the vapours. The latter was previously oven-dried and was used to measure the condensate collection rate, i.e., the distillation rate. The composition of the collected distillate was measured by NMR. Diphenyl ether solutions at different concentrations of PET flakes (1, 5, 10 and 20 g of PET in 100 mL of DPhE, corresponding to 10, 50, 100 and 200 g/l respectively) were prepared. The PET flakes were previously obtained from the corresponding bottles, cutting them into square flakes about 1 cm in size, dried for 30 minutes in an oven at 130° C. in vacuum.

The reaction temperature was increased to the boiling temperature of the solvent and, after complete dissolution of the PET, the catalyst was added at concentrations of 0.01-0.1%. The reaction was allowed to proceed at boiling temperature under magnetic stirring at 600 rpm for 6 hours and at a pressure of 300-500 mbar. This reaction time is in excess with respect to what is necessary and has been considered for a more complete kinetic analysis.

During the reaction, the pressure was adjusted by vacuum pump. Both the reaction temperature and the temperature inside the Vigreux column were measured with two K-type thermocouples.

At the end of the reaction, the reaction products were recovered according to the operating methods reported in Example 3.

The molar fractions of each component in both the reaction mixture and the distillate were measured by 1H-NMR (in CDCl3 and CDCl3/TFA-d 3:1, respectively).

### Example 1-A. Conventional Cyclo-Depolymerization of PET Bottle Flakes

A 250-mL three-necked flask, heated by an oil bath placed on a magnetic heating plate, was used as a reactor. The first lateral neck was used to measure the temperature by means of a thermocouple. The second lateral neck was used during the course of the reaction to withdraw the reaction samples by means of a spatula. These samples were then dried in a 120° C. oven. A spillway was installed on the central neck to condense the vapours. Diphenyl ether solutions at different concentrations of PET flakes (1, 5, 10 and 20 g of PET in 100 mL of DPhE, corresponding to 10, 50, 100 and 200 g/l respectively) were prepared. The PET flakes were previously obtained from the corresponding bottles, cutting them into square flakes about 1 cm in size, dried for 30 minutes in an oven at 130° C. in vacuum. During the reaction, the temperature was increased until boiling and, after complete dissolution of the PET, the catalyst was added at concentrations of 0.01-0.1%. The reaction was kept under stirring at 600 rpm for 6 hours at the boiling temperature. Then the reaction was quenched by cooling and the final solution was filtered. The distillate compositions such as those of the reaction mixture were measured by 1H-NMR (in CDCl3 and CDCl3/TFA-d 3:1, respectively), as described in Example 1. The results obtained with this example are reported and compared with those obtained with the method of the invention reported in FIG. 5. The advantages which emerge from the analysis of these graphs have already been discussed previously (pages 10-11, lines 25-33 and 1-12).

### Example 2. Removal of Contaminants by Partial (Cycle)-Depolymerization of PET Bottles Assisted by Distillation

A 250-mL, electrically heated, 3-necks flask provided with magnetic stirring was used as a reactor. The first lateral neck was used to measure the reaction temperature. Samples of the reaction mixture were taken from the second lateral neck during the reaction by means of spatulas previously dried in an oven at 120° C. A Vigreux column was installed on the central neck. A condenser was arranged at the top of said column to condense the vapours and collect the condensate in a flask, previously dried in an oven at 120° C. Weighing the collected quantities over time, the distillation rate was measured, while the composition of the distillate was evaluated by NMR.

Diphenyl ether solutions were prepared at different concentration of PET flakes. The PET flakes were previously obtained by the corresponding bottles, cutting them into square flakes about 1 cm in size, dried for 30 minutes in an oven at 130° C. in vacuum and then left to macerate at 50° C. under stirring in a solution at 2.5% m/m Menthol and 2.5% m/m Limonene in water for 24-72 h. The addition of Irganox® B 561 FF and Irgafos® 126 at a concentration of 0.15-0.5% was carried out directly in the reactor simultaneously with the addition of the flakes. The temperature was increased until boiling, and after complete dissolution of the PET, the catalyst was added at concentrations of 0.1-0.05%. The reaction mixture was kept stirred with a magnetic stirrer at 600 rpm for 6 hours at 300-500 mbar and at boiling temperature. The pressure was controlled by vacuum pump. Then the reaction was switched off. The reaction products were recovered according to the operating methods described in Examples 3 and 4. The temperature in the Vigreux column and the reaction column were measured with two K-type thermocouples. The compositions of the distillate and those of the reaction mixture were measured by 1H-NMR, in CDCl3 and in CDCl3/TFA-d 3:1, respectively.

### Example 3. Separation Method for Selective Thermal Precipitation (Step b1))

After the assisted cyclo-depolymerization (DA-CDP), the reaction mixture of Examples 1 and 1A is filtered at the boiling temperature of the solvent to eliminate insoluble products such as inorganic fillers, metals, and any other polymer residues insoluble in the reaction solvent. The solution is then cooled to 150-160° C. At these temperatures high molecular weight components precipitate, which are then separated by filtration by Büchner filter. Then the filtered solution is further cooled to temperatures between 25 and 30° C. At this temperature the low/medium molecular weight oligomers are precipitated, which are recovered by filtration by Büchner filter. The filtered solution is treated with n-hexane to precipitate the very low molecular weight oligomers, which are finally separated by filtration.

### Example 4. Separation Method for Direct Cold Precipitation (Steps b2) and b3))

After the assisted cyclo-depolymerization (DA-CDP), the reaction mixture of Examples 1 and 1A is filtered at the boiling temperature of the solvent to eliminate insoluble products such as inorganic fillers, metals, and any other polymer residues insoluble in the reaction solvent.

The solution is then cooled to 25 to 30° C. At this temperature, both high molecular weight polymers and low/medium molecular weight oligomers precipitate. The precipitates are separated by filtration with Büchner filter. The retentate collected on the filter is treated with DPhE to wash the solid, preferably at temperatures between 20 and 120° C., and eliminate the residual contaminants with a system of multiple washes (as in variant b2) of step b) described above) or counter-current (as in variant b3) of step b) described above).

The evaluation of the contaminant content was carried out by NMR analysis using CDCl3/TFA-d in 3:1 volumetric ratio as solvent.

### Example 5. Polymerization and Characterization of the Product

500 mg of the reaction mixture obtained as described in Examples 4 and 5 was loaded into a 5 ml Schlenk tube reactor, and 1500 mg of the same mixture was loaded into a 10 ml Schlenk tube reactor. Both reactors were placed in a heater block and vacuum-dried for about 30 minutes. The reactors are removed from the heater block and the vacuum is replaced by nitrogen.

The desired temperature (240-280° C.) is set in the heater block and the reactors are returned to the heater block.

Samples are taken during the reaction by means of spatulas previously dried in an oven at 120° C. After the desired time (10 to 60 min), the reaction is quenched by immersing the Schlenk tube in ice water.

The produced polymer (hereinafter referred to as r-PET to differentiate it from the virgin polymer) is dissolved in pure HFIP and subsequently precipitated by addition of THF. The product is then collected by filtration or centrifugation.

Another methodology includes dissolving the reaction product in pure HFIP followed by nocturnal evaporation of the solvent under extracted hood. The solid is vacuum-dried at 80° C. to yield a white product. The solid is analysed at NMR, (1H NMR (300 MHZ, 25° C., TFAd) (ppm)=7.45 (s, 2H, —CH—Ar—), 4.88 (s, 4H, —CH2-CH2-O—).

### Gas Permeability

The gas permeability of rPET was assessed at 25° C. and 50% relative humidity using a MOCON Ox-Tran device using polymer films between 12 and 90 μm thick, with a surface area between 5 and 50 cm² and a gas flow rate of 10 cm³/min. The calibration of the device was carried out with a standard PET supplied by the manufacturer.

The preparation of the film for permeability analysis was carried out by pouring a solution of about 150 mg/mL of rPET into HFIP on a glass plate heated to 60° C. inside a ventilated stove to evaporate the solvent. After this step, the permeability of the film was measured, also performing thickness measurements both before and after the permeability measurement to verify the integrity of the film itself.

The results demonstrate that rPET exhibits a permeability quite like that of non-recycled PET, as underlined on page 16, lines 11-13 of the present disclosure.

### Mechanical Tests

### Cryo Grinding

r-PET was dried for one day in a vacuum oven at 130° C. The dried polymer was pulverized in a Freeze/Mill 6770 device under liquid nitrogen for 3 cycles of 5 minutes at 15 Hz.

### Compression Moulding

The compression moulding step was accomplished using a commercial hot press (Rondol Technology Ltd, Stoke-on-trent, UK). The cryo-milled r-PET powder as described above was placed in a square-shaped mould to which a force of about 3 kN was applied for 3 min by means of the aforesaid hot press at a temperature of 260° C., sufficient to melt the powder. Cooling is then obtained by placing the mould under a cold press equipped with a water cooling system operating at 8° C. rPET film of a thickness of 0.06 to 0.08=0.001 mm suitable for permeability testing is then obtained.

### Behaviour Under Stress

Dumbbell (or dog bone) shaped samples 1.25 mm wide and 5 mm long were cut by compression moulding (ISO 527-2, type 5B). Uniaxial stress/strain diagrams were constructed starting from 0.5 sec⁻¹ stress measurement. The calculated values of mechanical properties, such as Young's modulus, yield stress, and fracture strength, are the average of at least five measurements. All the mechanical tests were performed at room temperature (25° C.). The stress in all the diagrams is understood as the nominal stress. All the tests were performed both in parallel and perpendicular with respect to the visible fibres.

These tests demonstrate that the polymer obtained by the process of the invention is fragile; therefore, in step c) it is preferable to add conventional stabilizers and performers to allow to obtain a polymer with properties such as elongation at break comparable to those of polymers of the same type prepared from scratch.

### Example 6. Recovering and Recycling PET from Multicolour Bottles

The experimental set to conduct the DA-CDP includes thermal-heating mantle, 250 ml flask, Vigreux column, Liebig condenser, distillate collection flask, vacuum pump and stirring system (mechanical or magnetic).

100 ml of DPhE and 10-40 g of previously shredded bottles are loaded into the aforesaid 250 ml flask. The pressure is set around 400 mbar in order to ensure a solvent evaporation temperature of about 218° C. The heating mantle is lit and heat up to the boiling point. At this point, all of the polymer is completely dissolved except for any coarse and insoluble foreign bodies, which can be easily removed. 0.05% of catalyst (antimony oxide) is then added and 2 to 4 h of reaction is expected, maintaining a vapour removal by distillation of about 3 g/h. During this step, the by-products of the reactions described above and the volatile contaminants resulting from the decomposition and absorption of the polymer during its normal life and use are also distilled together with the solvent.

### Example 7. Polyester Recovery and Recycling from Polyester Fibres

The experimental set to conduct the DA-CDP includes thermal-heating mantle, 250 ml flask, Vigreux column, Liebig condenser, distillate collection flask, vacuum pump and stirring system (mechanical or magnetic). 100 ml of a DPhE solution of pre-shredded fibres with an estimated polyester content of 10 to 40 g are loaded into the aforesaid 250 ml flask. The pressure is set around 400 mbar to ensure a solvent evaporation temperature of about 218° C. The heating mantle is lit and heat up to the boiling point. At this point, all the polymer is completely dissolved except for any coarse and insoluble foreign bodies, which can be easily removed. It is in this step that the cotton fibre, elastane, etc. is then removed, 0.05% catalyst (e.g., antimony oxide) is then added and 2 to 4 h reaction is expected while maintaining a distillation flow rate of about 3 g/h. During this step, the by-products of the reactions described above and the volatile contaminants resulting from the decomposition and absorption of the polymer during its normal life and use are also distilled together with the solvent.

### Example 8. Hot-Cold Filtration

After the mixture has reacted for the time indicated in Examples 7 and 8, the reaction mixture is transferred to a beaker after filtration at the boiling temperature to remove any foreign bodies. The solution is then cooled to about 140° C., at which temperature the most massive precipitation of the polymer occurs and is then separated. The remaining solution is then further cooled to room temperature, so that various lower molecular weight oligomers precipitate. Then a washing of the solid compounds obtained with 50 ml of pure solvent follows. The solids from the hot and cold precipitation are then pooled to obtain the cyclic oligomer-polymer blend ready to be repolymerized.

### Example 9. Cold Direct Filtration

After the mixture has reacted for the time indicated in Examples 7 and 8, the polymer is transferred to a beaker after hot filtration to remove any foreign bodies. The solution is then cooled to room temperature until complete precipitation of both the high molecular weight polymer and oligomers. This is followed by washing the solid compounds obtained with 100 ml of pure solvent pre-heated at around 100° C. to maximize the effectiveness in the removal of the dyes. The thus bleached solids, free the dyes and heavy contaminants soluble in the solvent, constitute the cyclic oligomer-polymer mixture ready to be repolymerized.

### Example 10. Repolymerization

The cyclic polymer-oligomer mixture is charged under mechanical stirring in a Schlenk tube reactor or in a flask. Operating under vacuum to remove any residual solvent, the system is brought to a temperature between 240 and 280° C., at which temperature the repolymerization reaction occurs. During this method step, both polycondensation and ring opening polymerization (ROP) reactions occur simultaneously. In 10 minutes the bottle grade is reached and in 20-30 minutes the maximum growth of the molecular weight of the polymer is reached.

Given the high temperature, after this time the normal phenomena of thermal decomposition of the polymer begin. To mitigate such phenomena, it is sufficient to add conventional commercial antioxidants. Such addition may not be necessary if the reaction is stopped at short times but still sufficient to produce a polymer ready to meet market needs.

Given the high reaction rate, repolymerization can be envisaged by feeding the cyclic polymer-oligomer mixture directly to a commercial extruder operating at temperatures of 260° C. and with residence times of 10-15 minutes.

1. A process for preparing polyesters and polyamides from the corresponding polymeric waste products, comprising the following steps:
a) partially depolymerizing the polyester or polyamide thereby obtaining a solution of polymer and oligomers,
b) purification of the products from step a) and recovery thereof in the form of a solid mixture;
c) polymerization of the solid mixture from step b),
wherein
in step a) the depolymerization is only partial and results in a mixture of cyclic oligomers, aliphatic oligomers and starting polymer
said step a) is carried out in a polar aprotic solvent starting from a concentration of from 10 to 800 g/l of said polymeric waste product at the solvent boiling temperature ranging from 100° and 300° C. and in the presence of a catalyst, simultaneously distilling the reaction solvent.

2. The process according to claim 1, wherein the waste polymer products are polyester and polyamide materials, more preferably colourless and coloured flakes of polyethylene terephthalate bottles, polyamide and polyester fibres, polyester trays and laminates, polyethylene furanoate products.

3. The process according to claim 1, wherein the solvent is selected from a diaryl ether, mono/di/tri-C1-C3-alkoxy-benzene, aryl-C1-C3-alkyleneoxy-C1-C5-alkane, di-(aryl-C1-C3-alkylene)-ether, aryl-C1-C3-alkylene-oxo-benzene, C4-C6 cycloalkyl-ketone, in which the aryl is a phenyl or a phenyl substituted with one or more linear or branched C1-C3 alkyl residues.

4. The process according to claim 3, wherein said aprotic polar solvent is selected from: diphenyl ether, 1,3-dimethoxybenzene, benzyl methyl ether, benzyl butyl ether, di-benzyl ether, cyclohexanone, benzophenone.

5. The process according to claim 1, wherein step a) is carried out by using diphenyl ether as solvent, at a reaction temperature between 100° and 240° C., at a pressure between 1 and 1000 mbar. in inert gas.

6. The process according to claim 1 wherein said catalyst is selected from organometals metal-oxides and mixtures thereof.

7. The process according to claim 1, wherein the solvent in step a) is diphenyl ether and step a) is carried out at temperatures between 208 and 224° C., at pressures between 300 and 500 mbar, for a time between 2 and 4 hours.

8. The process according to claim 1, wherein step b) comprises a step b1.1) or b2.1) or b3.1) of eliminating the insoluble impurities, by filtration, centrifugation, pressing or decanting of the reaction mixture from step a) at the solvent boiling temperature wherein:
the reaction mixture from step b1.1) is subjected to a treatment comprising the following steps:
b1.2) in which said reaction mixture is subjected to cooling of the reaction mixture to the temperature at which the unreacted polymer precipitates, which is recovered by filtration; in the case of PET, this temperature is between 140 and 180° C.;
b1.3) after the removal of the polymer, the permeate is subjected to further cooling to room temperature, temperature at which the low and medium molecular weight cyclic oligomers precipitate, which are recovered by filtration, centrifugation, pressing or decanting;
and possibly:
b1.4) in which the filtered solution from step b1.3) is added with a hydrocarbon solvent, to allow the precipitation of the lower molecular weight oligomers;
the reaction mixture from step b2.1) is subjected to a cooling step b2.2) at a temperature between 20 and 40° C., at which both the unreacted polymer and the oligomers precipitate, which are separated from the solvent by filtration and subsequently washed with pure solvent, preferably at temperatures between 90 and 120° C., to eliminate the colouration of the polymers and further impurities.
the filtrate from step b3.1) is subjected in step b3.2) to cooling to a temperature between 20 and 40° C.; the precipitate thus obtained is washed in counter-current in step b3.3) with ketone solvent at temperatures between 20° C. and the solvent boiling temperature, to remove both the dyes and the contaminants.

9. The process according to claim 8, wherein, when the waste products are polyethylene terephthalate flakes and the solvent of step a) is diphenyl ether, the cooling temperature of step b1.2) is between 140 and 160° C. and the temperature at which the product is washed in step b1.3) is between 90 and 120° C.

10. The process according to 8, wherein the filtrate from step b3.1) is subjected in step b3.2) to cooling to a temperature between 25 and 30° C.; the precipitate thus obtained is washed in counter-current in step b3.3) with preferably acetone at temperatures between 20° C. and the solvent boiling temperature, to remove both the dyes and the contaminants.

11. The process according to claim 8, wherein by using one of the following products or a mixture thereof:
(i) high molecular weight polymers from step b1.2),
(ii) low/medium molecular weight oligomers from step b1.3),
(iii) lower molecular weight oligomers from step b1.4),
(iv) the polymeric-oligomeric mixture from purification method b2-2),
(v) the polymeric-oligomeric mixture from purification process b3-3),
the mass polymerization (step c)) is carried out at temperatures between 240 and 280° C. for a time between 10 and 30 minutes.

12. The process according to claim 11, wherein, by using one or more of the products (i)-(v) in mixture with virgin PET, a mass polymerization (step c)) is carried out at temperatures between 240 and 280° C., for a time between 10 and 30 minutes.

13. The process according to claim 12, wherein the polymerization is carried out in an extruder for a time between 10 and 15 minutes at 240-280° C.

14. The process according to claim 11, wherein stabilizers, dyes and performers customarily used in this type of polymerization are added in step c).

15. The process according to claim 1, wherein at least one of the steps a)-c) is carried out continuously.

16. The process according to claim 15, wherein at least two of steps a)-c) are carried out continuously.

17. The process according to claim 15 wherein all three steps a)-c) are conducted continuously.
